(19) United States
(12) Patent Application Publication
(10) Pub. No.: US 2012/0169490 A1
(43) Pub. Date: Jul. 5, 2012

(54) WATER LEVEL AND TEMPERATURE ALERT DEVICE AND KIT

(75) Inventors: SEN-LIN YU, Taipei City (TW); TSAO-CHANG YU, New Taipei City (TW)

(73) Assignee: HON HAMN ENTERPRISE CO., LTD., New Taipei City (TW)

(21) Appl. No.: 12/984,688

(22) Filed: Jan. 5, 2011

(51) Int. Cl. G08B 19/00

(52) U.S. Cl. 340/522

(57) ABSTRACT

A water level and temperature alert device including a temperature sensor, a level sensor, an alert unit, and a computing unit. The computing unit is connected to the temperature sensor, the level sensor, and the alert unit. The level sensor is connected to a first electrode and a second electrode. When the first and second electrodes are shorted, the level sensor would output a triggering signal to the computing unit. As the computing unit is enabled by the triggering signal, the computing unit further attains a water temperature signal off the temperature sensor. According to the temperature range where the temperature signal falls into, the computing unit would trigger the alert unit to illuminate in different colors. The aforementioned alert device can further transmit the temperature and power level data to a remote host unit or communication device via a wireless technology.

### FIELD OF THE INVENTION

The instant disclosure relates to a water level and temperature alert device and kit; in particular, to an alert device and kit for detecting water level and water temperature, and providing an alarm indication.

### DESCRIPTION OF RELATED ART

Often times, people would fill the bathtub while attending other matters, which can cause the bathtub to be overfilled. In other instances, people would check the bathtub intermittently to inspect the water level while filling, wasting valuable time. In addition, when the bathtub reached desired water level, people often check the water temperature physically and receives burn injuries.

Furthermore, when elders or children are bathing, other family members outside of the shower room do not know the water temperature. Thereby, when the water is too hot, the water supply is not turned off in time, which can cause burn injuries to the elders or children as well.

### SUMMARY OF THE INVENTION

An embodiment of the instant disclosure provides a water level and temperature alert device and kit. The main objective is to detect the water level and temperature of the bathtub. Also, when the water has reached a pre-determined level, the water temperature data is fed to a remote host unit wirelessly. In turn, the person is alerted by sound, lighting, and numerical temperature indication.

Based on one embodiment, the water level and temperature alert device of the instant disclosure comprises a temperature sensor, a level sensor, an alert unit, and a computing unit. The level sensor is connected to a first electrode and a second electrode. When the first and second electrodes are shorted, the level sensor would output a triggering signal to the computing unit. Upon receiving the triggering signal, the computing unit is enabled and further obtains a water temperature signal off the temperature sensor. Based on the corresponding temperature value of the water temperature signal, the computing unit would enable the alert unit, causing the alert unit to illuminate with different colors.

According to another embodiment, the water level and temperature alert device of the instant disclosure comprises a computing unit, which is connected to a temperature sensor, a level sensor, an alert unit, and a wireless transmitting module. The level sensor is connected to a first electrode and a second electrode. When the first and second electrodes are shorted, the level sensor would output a triggering signal to the computing unit. Upon receiving the triggering signal, the computing unit is enabled and further obtains a water temperature signal off the temperature sensor. Based on the corresponding temperature value of the water temperature signal, the computing unit would enable the alert unit, causing the alert unit to illuminate with different colors. Also, the water temperature signal is fed wirelessly to a communication device via the wireless transmitting module.

Still further according to another embodiment, the kit for the water level and temperature alert device comprises an alert device and a host unit. The alert device comprises a computing unit, which is connected to a temperature sensor, a level sensor, an alert unit, and a wireless transmitting module. The level sensor is connected to a first electrode and a second electrode. When the first and second electrodes are shorted, the level sensor would output a triggering signal to the computing unit. Upon receiving the triggering signal, the computing unit is enabled and further obtains a water temperature signal off the temperature sensor. Based on the corresponding temperature value of the water temperature signal, the computing unit would enable the alert unit, causing the alert unit to illuminate with different colors. Also, the water temperature signal is fed wirelessly via the wireless transmitting module.

The host unit comprises a wireless receiving module, an alarm unit, and a host computer. The host computer is connected to the wireless receiving module and the alarm unit. The host computer receives the water temperature signal via the wireless receiving module. Based on the corresponding temperature value of the received water temperature signal, the host computer would trigger the alarm unit to give off audio and lighting signals.

Based on the above, the water level and temperature alert device for the embodiment of the instant disclosure uses the alert unit to illuminate and sound off, in order to remind the user about the water level and temperature of the bathtub. Thereby, safety is enhanced for bathing along with saving water supplies. In addition, the water level and temperature alert device for the embodiment of the instant disclosure feeds real-time water temperature data to a remote source wirelessly. The capability enables the host unit or communication device of the remote source to monitor the water temperature of the bathtub remotely, which helps in looking after elders and children.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a functional block diagram for an alert device for an embodiment of the instant disclosure.

FIG. 2 shows a schematic view of an alert device for an embodiment of the instant disclosure.

FIG. 3 shows a schematic view of an alert device in use for an embodiment of the instant disclosure.

FIG. 4 shows a functional block diagram for an alert device for another embodiment of the instant disclosure.

FIG. 5 shows a schematic view of an alert device in use for another embodiment of the instant disclosure.

FIG. 6 shows a functional block diagram of a host unit for an embodiment of the instant disclosure.

FIG. 7 shows a schematic view of a kit for an embodiment of the instant disclosure.

FIG. 8 shows a functional block diagram of a host unit for another embodiment of the instant disclosure.

FIG. 9 shows a schematic view of a kit for another embodiment of the instant disclosure.

FIG. 10 shows an operation flow chart for an alert device for another embodiment of the instant disclosure.

### DETAILED DESCRIPTION OF PREFERRED EMBODIMENTS

The main objective of the water level and temperature alert device provided by the embodiment of the instant disclosure is to inspect the water level and temperature in a bathtub. When the water has reached a desired level, different alarm lights is illuminated based on the corresponding water temperature at that moment, to fulfill the water temperature alarming capability.

In addition, the water level and temperature alert device of the embodiment for the instant disclosure can further feeds the water temperature signal to a remote host unit or communication device wirelessly. Based on the range wherein the water temperature falls into, the remote host unit or communication device would give off different alarm lights and sounds, in addition to display the water temperature value.

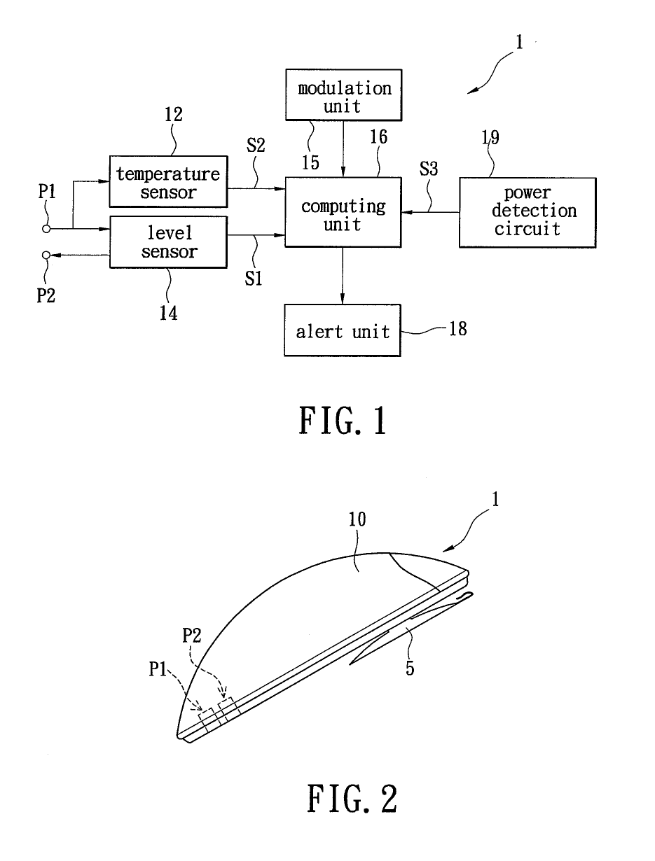

Please refer to FIG. 1, which shows a functional block diagram for an alert device of an embodiment of the instant disclosure. The alert device 1 includes a temperature sensor 12, a level sensor 14, an alert unit 18, and a computing unit 16. The computing unit 16 is connected to the temperature sensor 12, the level sensor 14, and the alert unit 18.

The level sensor 14 is connected to a first electrode P1 and a second electrode P2. When the first and second electrodes P1 and P2 are shorted, the level sensor 14 would output a triggering signal S1 to the computing unit 16. The computing unit 16 is enabled by the triggering signal S1, and then receives a water temperature signal S2 from the temperature sensor 12. Based on the temperature range which the water temperature signal S2 falls into, the computing unit 16 would trigger the alert unit 18 to illuminate in different colors accordingly. The aforementioned computing unit 16 can be an integrated circuit (IC), a micro control unit (MCU), or a chip. The computing operation can be carried out by a hardware circuitry and/or through software programs.

Please refer back to FIG. 1. The computing unit 16 is further connected to a power detection circuit 19, used for detecting the battery (not shown in FIG. 1) power of the alert device 1. The computing unit 16 receives the detected power level signal S3 from the power detection circuit 19, wherein the aforementioned battery is mainly used for powering all electronic elements of the alert device 1. In addition, when the computing unit 16 has determined the battery is low in power (i.e. the power signal is below a threshold value), the computing unit 16 would trigger the alert unit 18 to flash a green light, for alerting the user to change the battery.

Please refer again to FIG. 1. When the alert device 1 is added to the bathtub for alarming purpose regarding the water level and temperature, the locations of the first and second electrodes P1 and P2 correspond to the preset water level. Thereby, when the water reaches the preset level, the water within the bathtub would short out the first and second electrodes P1 and P2. At such moment, based on short circuit condition, the level sensor 14 would output a triggering signal S1 to the computing unit 16.

In other words, based on the change in impedance between the first and second electrodes P1 and P2, the level sensor 14 determines whether the first and second electrodes P1 and P2 have been shorted. When short circuit occurs, low impedance, instead of high impedance, is generated between the first and second electrodes P1 and P2. In addition, one of the first and second electrodes P1 and P2 can be assigned as a temperature detection electrode for the temperature sensor 12. As shown in FIG. 1, the first electrode P1 is picked as the temperature detection electrode for the temperature sensor 12 for the instant embodiment.

Still further refer to FIG. 1. After receiving the triggering signal S1, the computing unit 16 is enabled, namely from sleep mode to operation mode. At this moment, the computing unit 16 receives the water temperature signal S2 from the temperature sensor 12, and executes a determination procedure to determine the respective temperature range for the water temperature signal S2. The aforementioned temperature sensor 12 is an analog-to-digital converter, for converting the analog signal into a readable digital signal for the computing unit 16.

For the instant embodiment, the determination procedure executed by the computing unit 16 is pre-configured with three temperature ranges. Namely, the first temperature range can be set for below 30 degree Celsius, the second temperature range is from 30 to 42 degree Celsius, and the third temperature range can be set above 42 degree Celsius. However, the three pre-configured temperature ranges of the instant embodiment are by no means restricted thereto. Based on application, the temperature ranges can be modified for including in the determination procedure by rewriting the software programs.

Specifically, when the computing unit 16 has determined the temperature associated with the temperature signal S2 is below 30 degree Celsius, the alert unit 18 is triggered by the computing unit 16 to illuminate a still blue light, which indicates the water temperature is too low. If the computing unit 16 has determined the temperature signal S2 is for the range from 30 to 42 degree Celsius, the alert unit 18 is triggered accordingly to flash an orange light, which indicates the water temperature is appropriate for bathing. On the other hand, when the computing unit 16 has determined the temperature signal S2 is for the range of over 42 degree Celsius, the alert unit 18 is triggered to flash a red light, which indicates the water temperature is too high. The aforementioned alert unit 18 is an LED (light-emitting diode) module, or can be a RGB (red, green, blue) tri-color LED module, which would illuminate different colors according to the output signal from the computing unit 16.

Still further refer to FIG. 1, where the computing unit 16 is connected to a modulation unit 15. Based on the user input, the modulation unit 15 adjusts the preset temperature ranges of the computing unit 16 for the corresponding light colors. In other words, based on needs, the user can adjust the desired temperature ranges for corresponding light colors via the modulation unit 15.

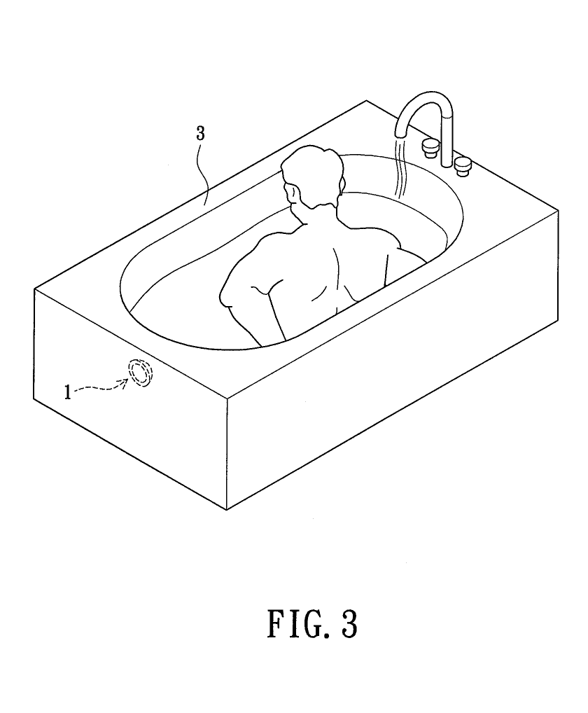

Please refer to FIG. 2 in conjunction with FIG. 1. FIG. 2 shows a schematic view of the alert device for the instant embodiment. The alert device 1 includes a casing 10, wherein the casing 10 encloses all aforementioned components of the alert device 1, and the casing 10 is water-proofed. As shown in FIG. 2, the first and second electrodes P1 and P2 are exposed off the outer surface of the casing 10, for detecting the water level. As mentioned before, the first electrode P1 is further assigned to be the temperature detection electrode for the temperature sensor 12 for gauging the water temperature.

Please refer again to FIG. 2 in conjunction with FIG. 3, wherein the casing 10 has a display area and a fixing area. The display area is for the user to see the lightings of corresponding water temperatures, while the fixing area is connected to a mounting seat 5. Thereby, via the mounting seat 5, the alert device 1 can be disposed on the recessed surface of the bathtub 3. The objective is to detect the water level in the bathtub 3 in real-time, as shown in FIG. 3. Also, when the water has reached the preset level, the user is alerted with the condition of the water temperature by different color lights. The aforementioned mounting seat 5 can be a suction disc.

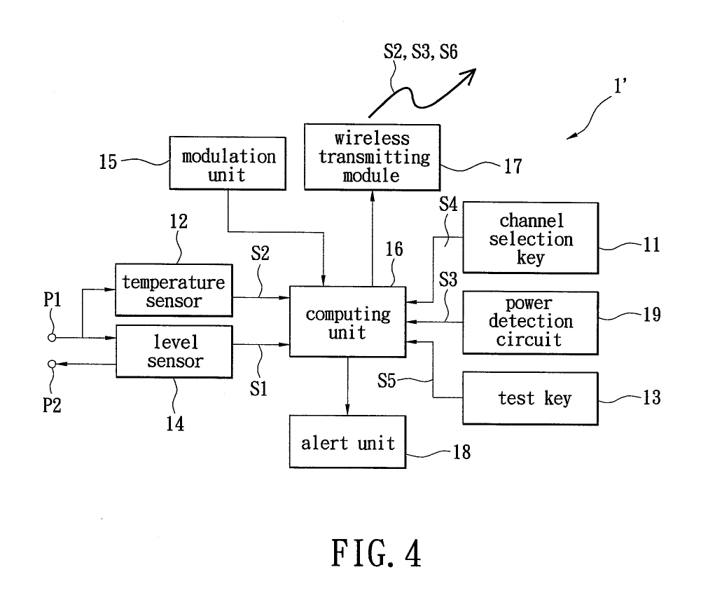

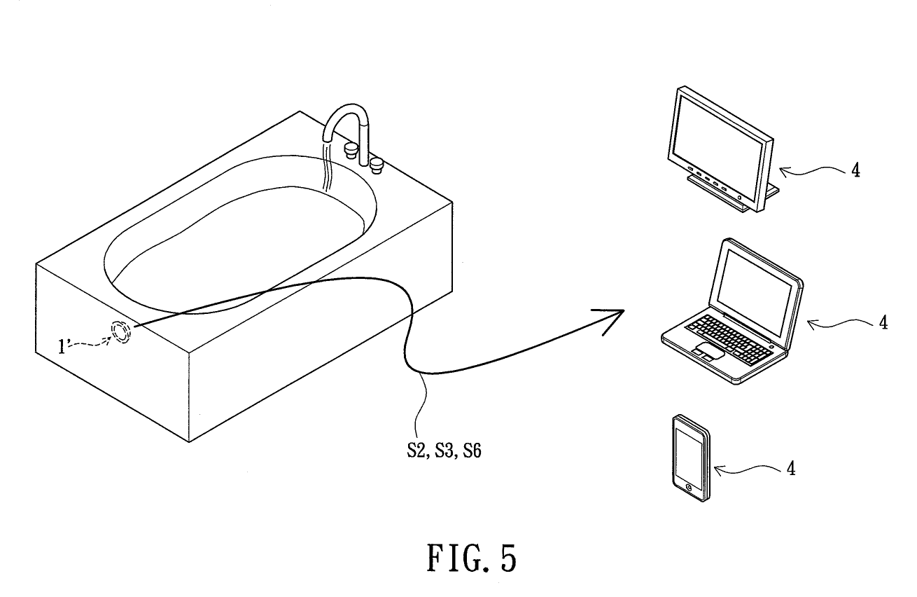

Please refer to FIG. 4 in conjunction with FIG. 1, where FIG. 4 shows a functional block diagram for another embodiment of the instant disclosure. In comparing to the alert device 1 in FIG. 1, the alert device 1′ in FIG. 4 further includes a wireless transmitting module 17. The wireless transmitting module 17 is connected to the computing unit 16. Thereby, after the computing unit 16 is enabled upon receiving the triggering signal S1, the computing unit 16 then receives the water temperature signal S2 from the temperature sensor 12. Via the wireless transmitting module 17, the computing unit 16 would feed the water temperature signal S2 wirelessly to a remote communication device 4, as illustrated in FIG. 5. In addition, after the computing unit 16 is enabled by the triggering signal S1, a power level signal S3 can also be fed wireless via the wireless transmitting module 17 to the remote communication device 4.

The aforementioned communication device 4 can be a laptop computer, a cell phone, a TV, a PDA (personal digital assistant), etc. of having signal receiving function. In addition, data transmission from the wireless transmitting module 17 of the alert device 1′ to the communication device 4 can be based on Wi-Fi, Bluetooth, UWB (ultra-wideband), or other wireless technology.

Please refer back to FIG. 4. The alert device 1′ further comprises a channel selection key 11, which is connected to the computing unit 16. The computing unit 16 receives a channel selection signal S4 from the channel selection key 11, and sets the wireless transmission channel of the wireless transmitting module 17 accordingly. Specifically, the user can operate the channel selection key 11 to switch the data transmission channel of the wireless transmitting module 17, for avoiding signal interference due to sharing the same channel.

Please refer back to FIGS. 4 and 5. The alert device 1′ further comprises a test key 13, which is connected to the computing unit 16. The computing unit 16 receives a test signal S5 off the test key 13 and is controlled thereby. The computing unit 16 also receives the power level signal S3 from the power detection circuit 19, and determines if the power level of the battery is at low voltage based on the power level signal S3. If indeed at low voltage, the computing unit 16 would control the alert unit 18 to give a low voltage warning. Conversely, if the voltage is deemed normal, the computing unit 16 would output a confirmation signal S6 along with the power level signal S3 wirelessly to the remote communication device 4 via the wireless transmitting module 17. The aforementioned confirmation signal S6 is displayed on the communication device 4, for allowing the user to confirm the network connectivity between the communication device 4 and the alert device 1′.

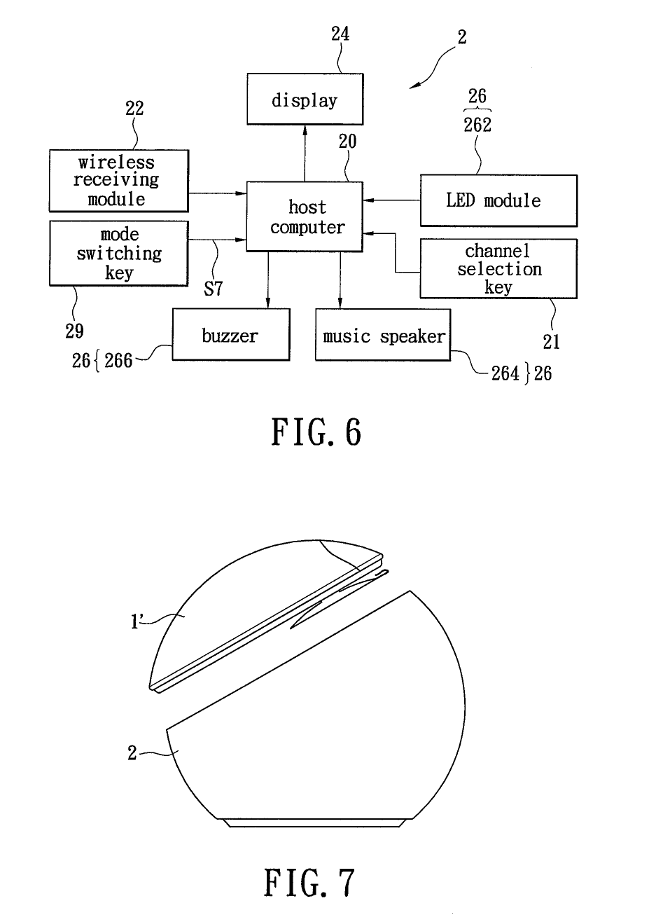

Please refer to FIG. 6 in conjunction with FIG. 4. FIG. 6 shows a functional block diagram for a host unit of the instant embodiment. The host unit 2 of FIG. 6 and the alert device 1′ of FIG. 4 make up a kit. In other words, the host unit 2 and the alert device 1′ can be put together structurally. Namely, the alert device 1′ can be detachably mounted onto the host unit 2 as shown in FIG. 7. In addition, when the alert device 1′ and the host unit 2 are separated, wireless technology can be used to achieve data transmission there between.

Refer back to FIGS. 4 and 6, wherein the host unit 2 includes a wireless receiving module 22, an alarm unit 26, and a host computer 20. The host computer 20 is connected to the wireless receiving module 22 and the alarm unit 26. The host computer 20 receives the water temperature signal S2 from the alert device 1′ via the wireless receiving module 22. Based on the temperature range which the temperature signal S2 falls into, the host computer 20 would trigger the alarm unit 26 to output different light and audio signals. The aforementioned host computer 20 can be an integrated circuit (IC), a micro control unit (MCU), or a chip. The computing operation can be carried out by a hardware circuitry and/or through software programs.

Upon receiving the water temperature signal S2 by the host computer 20, the host computer 20 would execute a determination procedure to determine the temperature range where the received water temperature signal S2 falls into. For the instant embodiment, the determination procedure executed by the host computer 20 can be pre-configured with three temperature ranges. Namely, the first temperature range can be set for below 30 degree Celsius, the second temperature range is from 30 to 42 degree Celsius, and the third temperature range can be set for above 42 degree Celsius. However, the three pre-configured temperature ranges of the instant embodiment are by no means restricted thereto. Based on needs, the temperature ranges can be modified for including in the determination procedure by rewriting the software programs.

Specifically, when the host computer 20 has determined the temperature associated with the water temperature signal S2 is below 30 degree Celsius, the alarm unit 26 is triggered by the host computer 20 to illuminate a flashing blue light and sounds off a first music, indicating the water temperature is too low. If the host computer 20 has determined the water temperature signal S2 is for the range from 30 to 42 degree Celsius, the alarm unit 26 is triggered accordingly to flash an orange light and sounds off a second music, indicating the water temperature is appropriate for bathing. On the other hand, when the host computer 20 has determined the water temperature signal S2 is for the range of over 42 degree Celsius, the alarm unit 26 is triggered to flash a red light and sounds off a third music, indicating the water temperature is too high. The aforementioned alarm unit 26 includes an LED module 262, a music speaker 264, and a buzzer 266. The LED module 262 can further be a RGB tri-color LED module, which illuminates in different colors based on the power output (e.g. voltage or current) from the host computer 20. Furthermore, the RGB tri-color LED module is a lamp LED made up by a plurality of RGB tri-colored LED lights arranged annularly. Meanwhile, the music speaker 264 is controlled by the host computer 20 to sound off different music.

As shown in FIG. 6, the host computer 20 is further connected to a display 24. Based on the water temperature signal S2, the host computer 20 would trigger the display 24 to show a water temperature value. At this moment, the LED module 262 of the alarm unit 26 can be disposed within the display 24 to provide background lighting thereof. In addition, the host computer 20 is further connected to a mode switching key 29. The host computer 20 receives a mode selection signal S7 from the mode switching key 29. Based on the mode selection signal S7, the host computer 20 is operated under the first mode or the second mode. The first mode is time-based, while the second mode is temperature detection-based. When the host computer 20 is operated under the time mode, the display 24 is controlled to show the current time, and the alarm unit 26 can be triggered to flash a purple light and sound off a fourth music as an alarm clock. In other words, when the host computer 20 is operated under the time mode, the host computer 20 functions as a clock with alarm clock capability.

Conversely, when the host computer 20 is operated under the temperature detection mode, the water temperature signal S2 and power level signal S3 are received via the wireless receiving module 22. The water temperature value and the power level status are further shown on the display 24. When the power level signal S3 is below a pre-determined value of the host computer 20, the host computer 20 would determine the battery of the alert device 1′ to be at low power level status (power level signal S3 below a pre-determined value). At such moment, the host computer 20 would trigger the LED module 262 of the alarm unit 26 to flash a green light, and control the music speaker 264 and the buzzer 266 to make a warning noise (e.g. bibi sound) for alerting the user to change out the old battery. In addition, based on the temperature range associated with the received water temperature signal S2, the host computer 20 would trigger the alarm unit 26 to output different light and audio signals as already described previously, with no further details herein.

Please refer back to FIG. 6. The host computer 20 further includes a channel selection key 21, which is connected thereto. Based on the input of the channel selection key 21, the host computer 20 sets the wireless transmission channel for the wireless receiving module 22. Specifically, by operating the channel selection key 21, the wireless receiving module 22 can be operated under different channels, to avoid interference due to sharing the same transmission channel. More specifically, the user can operate the channel selection key 21 to let the host unit 2 and the alert device 1′ in having the same data transmission channel.

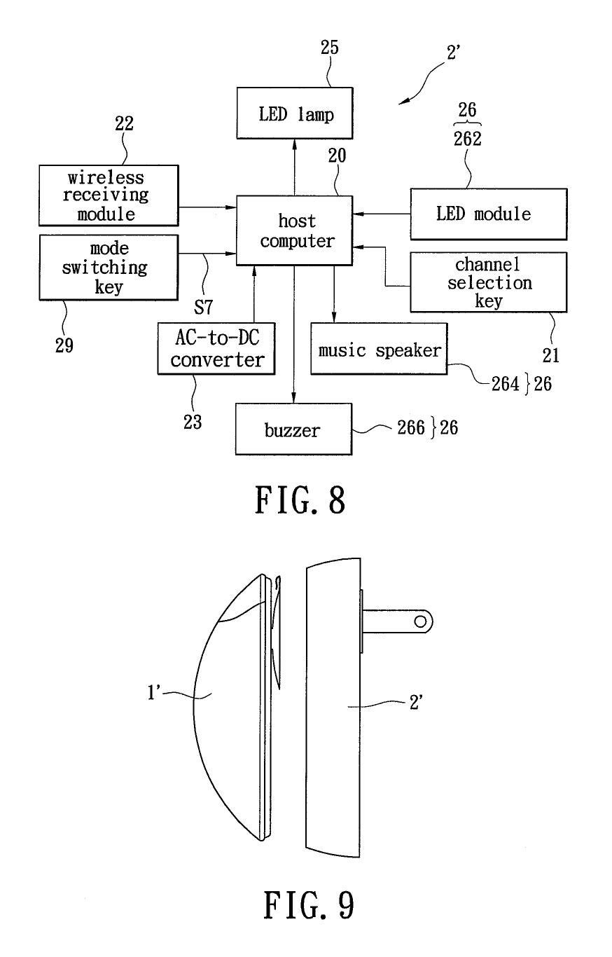

Please refer to FIG. 8 in conjunction with FIG. 6. FIG. 8 shows a functional block diagram for another embodiment of the instant disclosure. The host unit 2′ of FIG. 8 does not include the display 24 shown in FIG. 6. However, in comparing to the host unit 2 of FIG. 6, the host unit 2′ of FIG. 8 further included an AC-to-DC converter 23 and an LED lamp 25. The AC-to-DC converter 23 and the LED lamp 25 are both connected to the host computer 20. The AC-to-DC converter 23 is used to convert an alternating current (AC) into a direct current (DC), and supplies the DC to power the host computer 20.

In comparing to the host unit 2 of FIG. 6, the first mode of operation for the host unit 2′ of FIG. 8 is a night light mode. When the host computer 20 is operated under the night light mode, the LED lamp 25 is turned on for illumination. More specifically, when the host computer 20 is operated under the night light mode, the LED lamp 25 is controlled to illuminate different colors by sections or a uniform color.

Please refer to FIGS. 4 and 8. The host unit 2′ of FIG. 8 and the alert device 1′ of FIG. 4 can also form a kit. In other words, the host unit 2′ and the alert device 1′ can be structurally designed in a way for merging. More specifically, the alert device 1′ can be detachably assembled onto the host unit 2′, as shown in FIG. 9. When the alert device 1′ and the host unit 2′ are separated, wireless technology can be used to achieve data transmission there between.

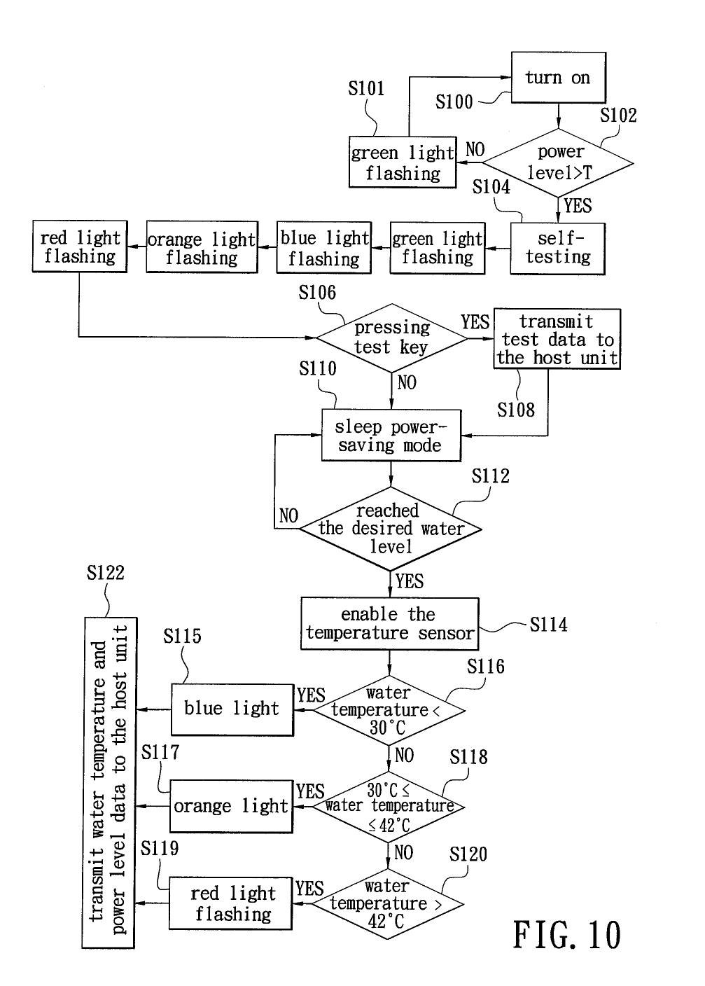

Please refer to FIG. 10 in conjunction with FIG. 4. FIG. 10 shows an operation flow chart for the alert device 1′. First, after the alert device 1′ is turned on (step S100), the computing unit 16 retrieves the power level signal S3 from the power detection circuit 19, and determines if the power level of the battery is greater than a pre-determined power level T (step S102). If the power level of the battery is not greater than the pre-determined power level T, the battery is deemed to be at low power status. At such moment, the computing unit 16 would control the alert unit 18 to flash a green light (step S101). Conversely, if the power level of the battery is greater than the pre-determined power level T, the power level of the battery is deemed normal. At such moment, the computing unit 16 would control the alert unit 18 to flash a green, a blue, an orange, and a red light in sequence for self-testing (step S104).

As shown in FIG. 10, when the test key 13 is pressed (step S106), the computing unit 16 is controlled by the test signal S5 and feeds test data to the remote host unit or communication device (step S108), as have done for the confirmation signal S6. After the test data had been fed, the computing unit 16 enters a sleep mode to save power (step S110), and determines if the water has reached the desired level (step S112).

When the water has reached the desired level, the computing unit 16 is waked up from the sleep mode after receiving the triggering signal S1, and enables the temperature sensor 12 (step S114) to detect the water temperature. Next, the computing unit 16 determines if the water temperature is less than 30 degree Celsius (step S116). If affirmative, the alert unit 18 would illuminate a blue light (step S115). If the water temperature is not less than 30 degree Celsius, the computing unit 16 would determine if the water temperature is somewhere from 30 to 42 degree Celsius (step S118). If affirmative, the alert unit 18 would illuminate an orange light (step S117). Next, if the water temperature is not somewhere from 30 to 42 degree Celsius, the computing unit 16 would continue to determine if the water temperature is above 42 degree Celsius (step S120). If affirmative, the alert unit 18 would flash a red light (step S119). In addition, while the computing unit 16 is determining the water temperature, the computing unit 16 would transmit the temperature and power level data to the remote host unit or communication device via the wireless transmitting module 17 (step S122).

Based on the above, the water level and temperature alert device for the embodiments of the instant disclosure uses the alert unit to illuminate different color lightings for alerting people with regard to water level and temperature of the bathtub. The instant disclosure enhances safety for bathing and also prevents wasting water supplies. In addition, the water temperature information of the bathtub can be transmitted wirelessly to the remote host unit or communication device for real-time monitoring, allowing to look after elders and small children.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A water level and temperature alert device, comprising:
a temperature sensor outputting a water temperature signal;
a level sensor connected to a first electrode and a second electrode, wherein the level sensor would output a triggering signal when the first and second electrodes are shorted;
an alert unit; and
a computing unit connected to the temperature sensor, the level sensor, and the alert unit, wherein the computing unit is enabled by the triggering signal and receives the water temperature signal after being enabled, and wherein according to a temperature range in which the water temperature signal falls into, the computing unit triggers the alert unit to illuminate in different colors.

2. The water level and temperature alert device of claim 1, wherein the computing unit is further connected to a power detection circuit, and wherein the computing unit receives a power level signal off the power detection circuit.

3. The water level and temperature alert device of claim 1, wherein the alert unit is an LED module.

4. The water level and temperature alert device of claim 1, wherein the computing unit is further connected to a modulation unit, wherein the modulation unit is used to adjust the preset temperature ranges of the computing unit and corresponding light colors.

5. The water level and temperature alert device of claim 1, further comprising a casing to encapsulate the temperature sensor, the level sensor, the alert unit, and the computing unit.

6. The water level and temperature alert device of claim 5, wherein the casing is connected to a mounting seat.

7. The water level and temperature alert device of claim 6, wherein the mounting seat is a suction disc.

8. A water level and temperature alert device, connected wirelessly to a communication device, comprising:
a temperature sensor outputting a water temperature signal;
a level sensor connected to a first electrode and a second electrode, wherein the level sensor would output a triggering signal when the first and second electrodes are shorted;
an alert unit;
a wireless transmitting module; and
a computing unit connected to the temperature sensor, the level sensor, the alert unit, and the wireless transmitting module, wherein the computing unit is enabled by the triggering signal and receives the water temperature signal after being enabled, and wherein according to a temperature range in which the water temperature signal falls into, the computing unit triggers the alert unit to illuminate in different colors, along with transmitting the water temperature signal wirelessly to the communication device via the wireless transmitting module.

9. The water level and temperature alert device of claim 8, wherein the computing unit is further connected to a channel selection key, the computing unit receives a channel selection signal off the channel selection key and sets the wireless transmission channel of the wireless transmitting module accordingly.

10. The water level and temperature alert device of claim 8, wherein the computing unit is further connected to a power detection circuit, the computing unit receives a power level signal off the power detection circuit.

11. The water level and temperature alert device of claim 10, wherein the computing unit is further connected to a modulation unit, wherein the modulation unit is used to adjust the preset temperature ranges of the computing unit and corresponding light colors.

12. The water level and temperature alert device of claim 10, wherein the computing unit is further connected to a test key, the computing unit receives a test signal off the test key, wherein the computing unit receives the power level signal from the power detection circuit according to the test signal, and wherein the computing unit transmits a confirmation signal and the power level signal wirelessly to the communication device via the wireless transmitting module.

13. A water level and temperature alert kit, comprising:
an alert device, comprising:
a temperature sensor outputting a water temperature signal;
a level sensor connected to a first electrode and a second electrode, wherein the level sensor would output a triggering signal when the first and second electrodes are shorted;
an alert unit;
a wireless transmitting module; and
a computing unit connected to the temperature sensor, the level sensor, the alert unit, and the wireless transmitting module, wherein the computing unit is enabled by the triggering signal and receives the water temperature signal after being enabled, and wherein according to a temperature range in which the water temperature signal falls into, the computing unit triggers the alert unit to illuminate in different colors, along with transmits the water temperature signal wirelessly via the wireless transmitting module.
a host unit, comprising:
a wireless receiving module receives the water temperature signal from the wireless transmitting module;
an alarm unit; and
a host computer connected to the wireless receiving module and the alarm unit, the host computer receives the water temperature signal from the wireless receiving module, wherein the host computer triggers the alarm unit to illuminate in different colors and sounds off in different music according to the temperature range in which the water temperature signal falls into.

14. The water level and temperature alert kit of claim 13, wherein the alarm unit comprises an LED module and a music speaker, and wherein the host computer triggers the LED module to illuminate in different colors and the music speaker to sound off different music according to the temperature range in which the water temperature signal falls into.

15. The water level and temperature alert kit of claim 14, wherein the host computer is further connected to a display, the host computer triggers the display to show a water temperature value according to the water temperature signal.

16. The water level and temperature alert kit of claim 14, wherein the host computer is further connected to an LED lamp.

17. The water level and temperature alert kit of claim 14, wherein the host computer is further connected to a buzzer.

18. The water level and temperature alert kit of claim 14, wherein the host computer is further connected to a mode switching key, the host computer receives a mode selection signal from the mode switching key and operates under a first mode or a second mode accordingly.

19. The water level and temperature alert kit of claim 18, wherein the host computer is further connected to an AC-to-DC converter, the AC-to-DC converter converts an alternating current to a direct current and passes the direct current to the host computer.
